(19) United States
(12) Patent Application Publication
(10) Pub. No.: US 2011/0208580 A1
(43) Pub. Date: Aug. 25, 2011

(54) SYSTEM AND METHOD FOR PLANNING MULTIPLE ADVERTISING WHEEL DIFFERENTIALS TO MAXIMIZE REVENUE ACROSS DISPARATE RETAIL ENVIRONMENTS

(75) Inventor: Robert I. Wolinsky, Fairfield, CT (US)

(73) Assignee: Automated Media Services, Inc.

(21) Appl. No.: 12/710,970

(22) Filed: Feb. 23, 2010

(51) Int. Cl. G06Q 30/00

(52) U.S. Cl. 705/14.48; 705/14.4; 705/14.69; 705/14.49

(57) ABSTRACT

A system and method for managing avails on advertisement wheels in different retail chains may include establishing a first and second number of avails on first and second display networks in first and second retail chains. The first number of avails may be less than the second number of avails. Total audience delivery of the first and second display networks may be determined. In response to an avail being booked, avail count of at least a portion of the first and second number of avails may be reduced. A determination that the avail count of the at least a portion of the first number of avails (e.g., national avails) on the first display network has reached zero may be made. The total audience delivery may be reduced by the audience delivery available to the first display network, and displayed to a next advertiser seeking to book an avail on the first and second display networks.

### BACKGROUND

Advertising in retail environments has been a way for product makers to convince shoppers to purchase goods of the advertisers. Traditionally, paper advertisements or promotional marketing advertisements were used. More recently, digital signage in the form of electronic displays has been used to promote goods. Studies have shown that product sales rise dramatically through the use of digital media, such as videos, that promote products in retail environments.

While many companies have attempted to develop digital signage, including advertising display networks in retail environments, most have failed for a variety of reasons. The science of retail environments has not been understood well enough by digital sign companies to profitably integrate display networks, and, as such, the ability of digital sign companies or media entities to integrate digital signs into retail environments has dramatically impacted profitability of these companies and desire for retailers to embrace digital signage. Since the 1980's, many digital sign companies have attempted to place digital sign networks within retail environments, but have failed or have had limited success. Some of the reasons for historical difficulty of integrating digital sign networks into retail environments include different retail environment parameters or disparate retail environments, such as different retail store configurations across different retail chains, different customer demographics and flows within different retail chains, different store sizes, different product offerings, and so on. Furthermore, management and distribution of content for display on electronic display networks located in different retail chains to maximize revenue given the disparate retail environments as described above is a problem heretofore not yet considered or solved.

### SUMMARY

The principles of the present invention provide for an electronic display network to be integrated into disparate retail environments (e.g., different retail chains) by being adapted to the different retail chain environments and shopper or audience metrics to maximize advertising revenue. The electronic display network across different retail chains provides for a number of slots in an advertisement wheel or loop within each different retail chain to be different lengths based on audience metrics within the different retail chains. Audience metrics are based on parameters of shoppers or customers (e.g., shopping trip periods) within retail stores of retail chains. In addition, the principles of the present invention may be adapted to address audience metrics in different retail stores within the same retail chain depending on the size, configuration, and audience metrics of shoppers within respective retail chains. Retail audience metrics may include an average time that shoppers shop at a retail store or within multiple stores in a retail chain. Advertisement wheels within different retail chains may be different lengths based on the audience metrics. For example, if audience metrics at one retail chain indicate that shoppers in that chain shop for 37 minutes on average, the advertisement wheel within that retail chain may be set longer than an advertisement wheel at a different retail chain where shoppers shop for 19 minutes on average so that each advertisement is delivered to each customer or member of a retail audience a predetermined number of views. Assuming that electronic displays that form an electronic display network distributed throughout a retail store are capable of being viewed by substantially all shoppers (audience delivery) that shop at the retail store to enable each shopper to view each ad a predetermined number of times (e.g., three times) (frequency of view), advertisers are provided with a predictable and plannable audience delivery to allow the advertiser to plan and purchase a certain number of viewers or audience delivery (e.g., rating points (RPs), as understood in the art) within a given designated market area (DMA), as defined by The Nielsen Company.

One embodiment of a method for managing avails (i.e., available inventory of timeslots) on advertisement wheels in different retail chains may include establishing a first number of avails on a first electronic display network in a first retail chain. A second number of avails may be established on a second electronic display network in a second retail chain. The first and second electronic display networks may be configured to receive advertising content for display in the avails via a communications network. The first number of avails may be less than the second number of avails based on retail audience metrics in the first and second retail chains. Total audience size or delivery available to the first and second electronic display networks may be determined. An avail may be reserved on both the first and second display networks in response to an advertiser booking content for display on the first and second retail networks. In response to the avail being booked, avail count of at least a portion of the first and second number of avails on the first and second electronic display networks may be reduced. A determination that the avail count of the at least a portion of the first number of avails (e.g., national avails) on the first display network has reached zero may be made. The total audience delivery of the combined networks may be reduced by the audience delivery available to the first electronic display network, and offered to a next advertiser seeking to book an avail on the first and second electronic display networks.

One embodiment of a method for managing national airtime on a network of multiple display networks located in respective multiple retail chains may include establishing multiple lists of avails associated with multiple respective retail chains that operate respective electronic display networks. An aggregate of the electronic display networks define a national electronic display network and the respective display networks define local electronic display networks. A respective number of avails may be established in each respective list of avails based on an average customer shopping time in each respective retail chain. At least a portion of the respective number of avails on each respective local electronic display network may be national avails, and a remaining portion of the respective number of avails on each respective local electronic display network may be respective local avails. A determination of audience delivery available for delivery by the national broadcast network based on customer traffic in each store in each respective retail chain may be made. A user interface may be provided for advertisers to book national avails for displaying content on the national electronic display network, where the user interface provides selectable dates during which content is to be run on the national electronic display network. In response to an advertiser selecting dates over which content is to be run on the national electronic display network, audience delivery to be delivered by the national electronic display network to the advertiser over the selected dates may be (i) calculated by adjusting audience delivery according to each retailer's display network and (ii) displayed for an advertiser to view. It should be understood that the same or analogous technique may be utilized by an individual retailer for managing airtime on its local electronic display network in the event that individual retail stores within a retail chain of the retailer are disparate such that different length advertisement wheels are utilized within the retail chain.

### BRIEF DESCRIPTION

Illustrative embodiments of the present invention are described in detail below with reference to the attached drawing figures, which are incorporated by reference herein and wherein:

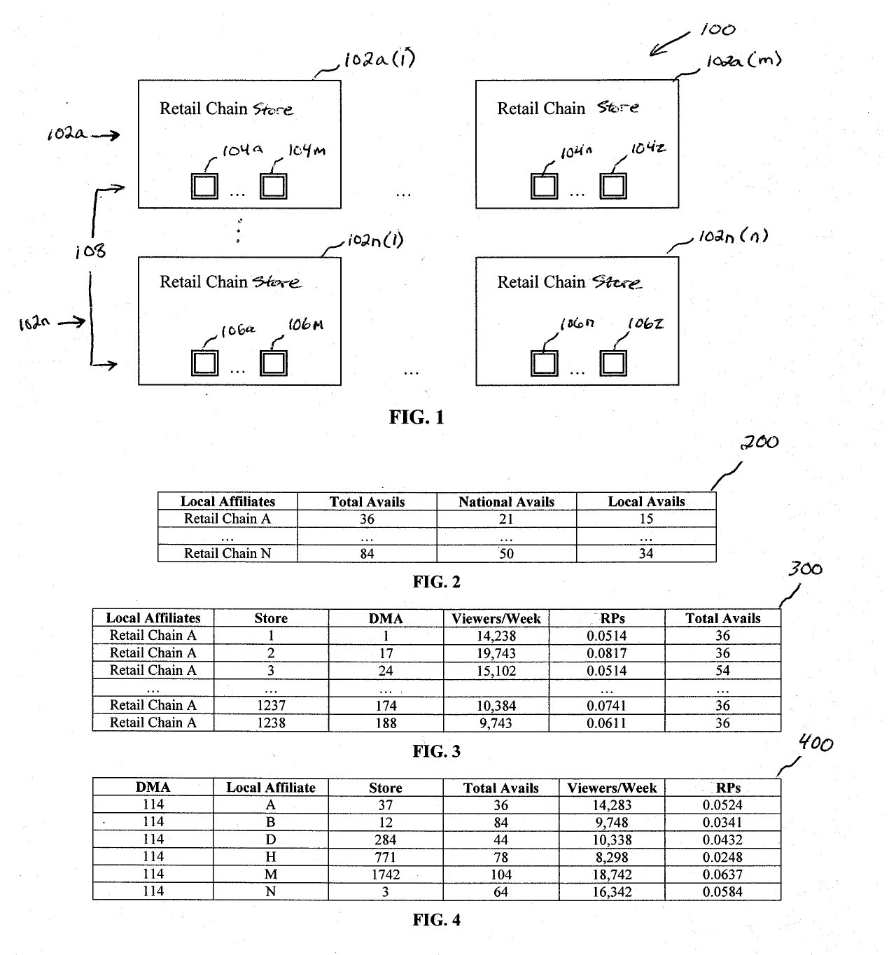

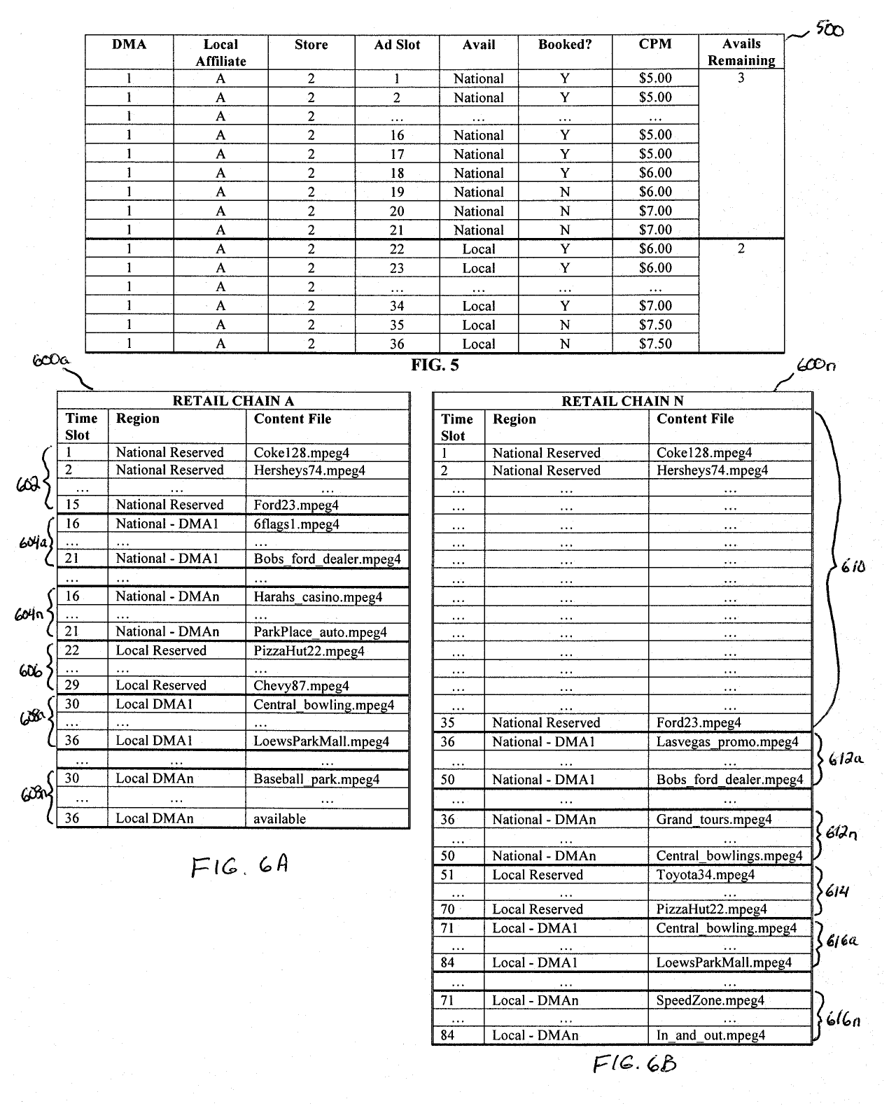

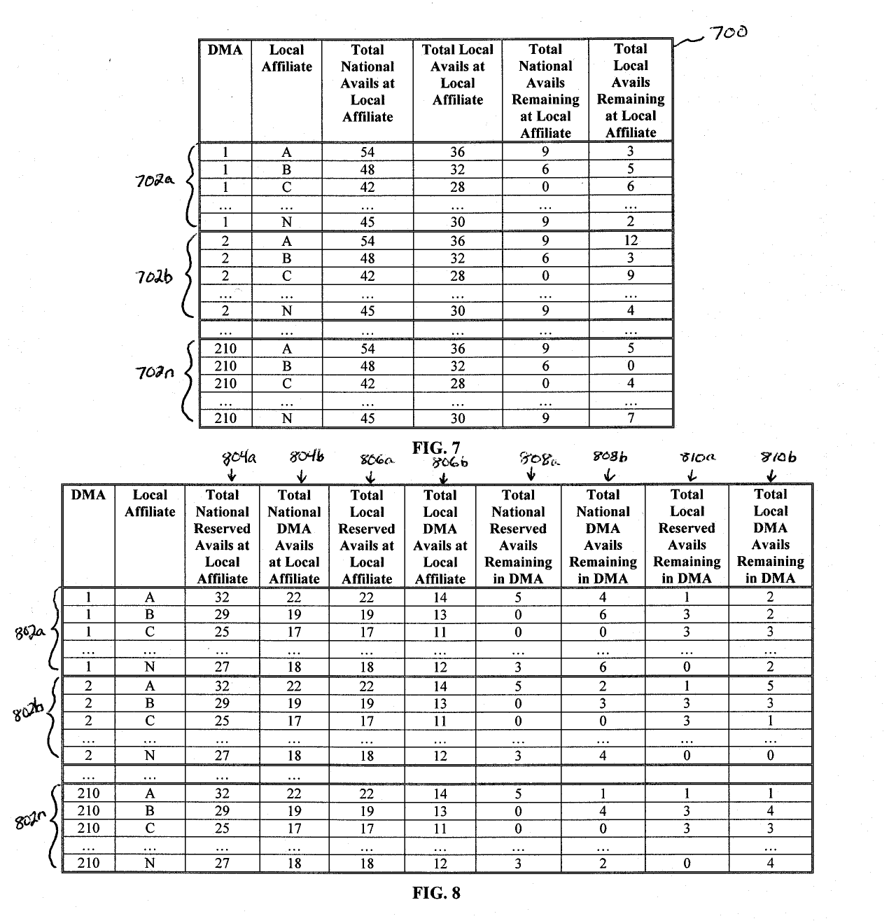

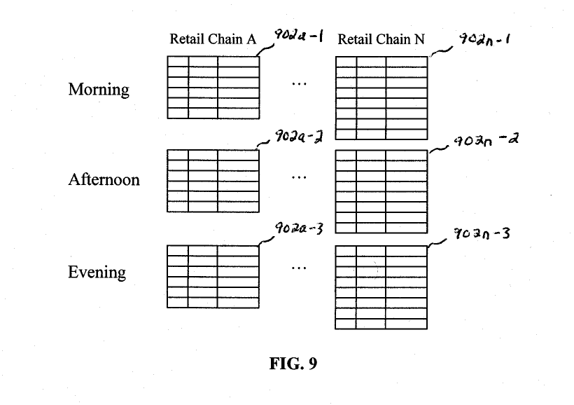

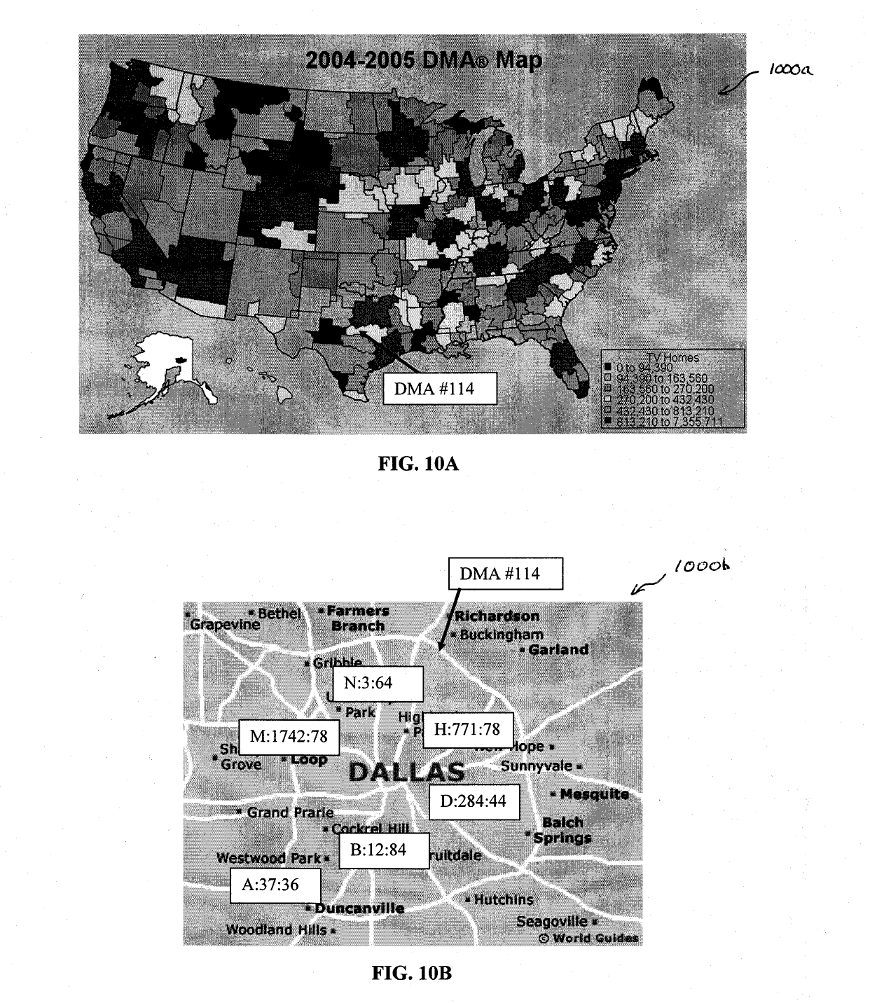

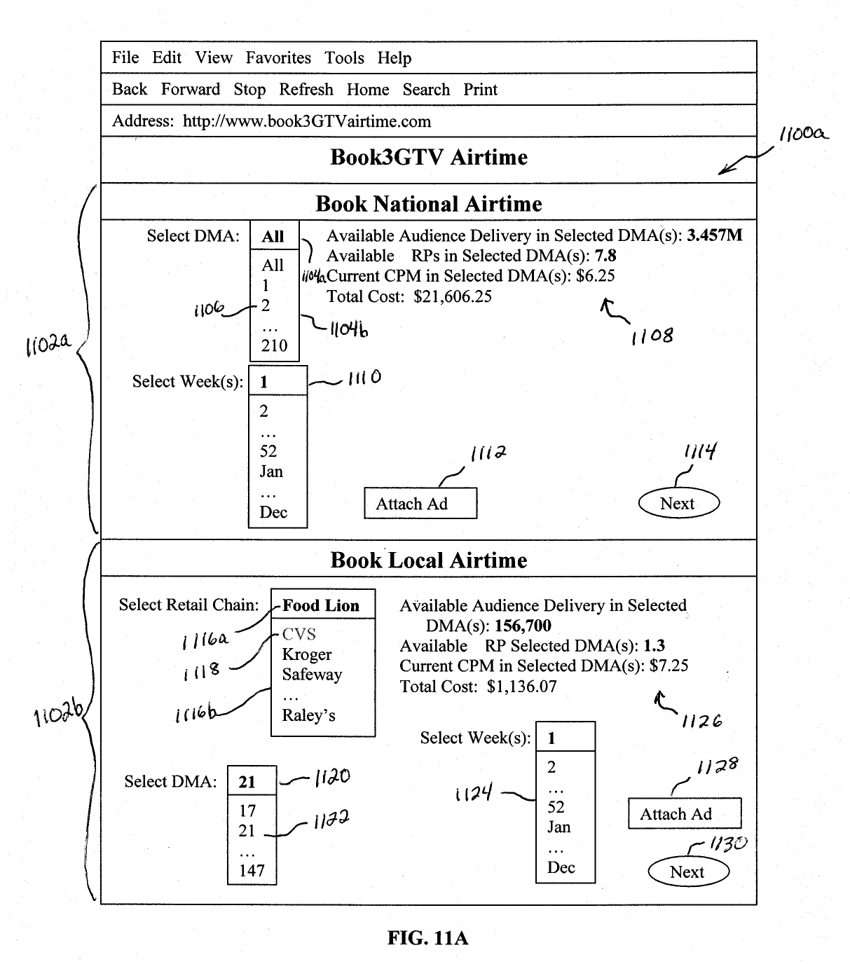

FIG. 1 is a block diagram of illustrative retail store chains that are local affiliates of a network service provider that operate electronic display networks in each respective retail chain that collectively form a single electronic display network;

FIG. 2 is a table of illustrative data for a network service provider in managing avails within advertising wheels associated with respective retail chain local affiliates of the network service provider;

FIG. 3 is a table of illustrative data used by a network service provider in managing and selling airtime on an electronic display network within retail environments of local affiliates;

FIG. 4 is a table of illustrative data used by the network service provider in managing airtime on an electronic display network in a particular designated market area;

FIG. 5 is a table of illustrative data for managing airtime on an electronic display network in a particular designated market area at a particular local affiliate and within a particular store of the local affiliate;

FIGS. 6A and 6B are listings of illustrative playlists of different lengths used for distributing content for display on an electronic display network within respective retail chains having different store parameters and shopper or audience metrics;

FIG. 7 is a table of illustrative data that enables a network service provider and its local affiliates to manage airtime on electronic display networks at retail stores of the local affiliates;

FIG. 8 is a table of more comprehensive illustrative data to enable the network service provider and its local affiliates to manage airtime on the electronic display networks within retail stores of the local affiliates;

FIG. 9 is an illustration of illustrative playlists of different lengths that may be used by the network service provider and its local affiliates for managing airtime in different day parts or time segments during which retail audience demographics (e.g., age, gender, lifestyle) may vary;

FIGS. 10A and 10B are illustrations of illustrative designated market area maps of the United States for determining media metrics for content reaching households throughout the United States;

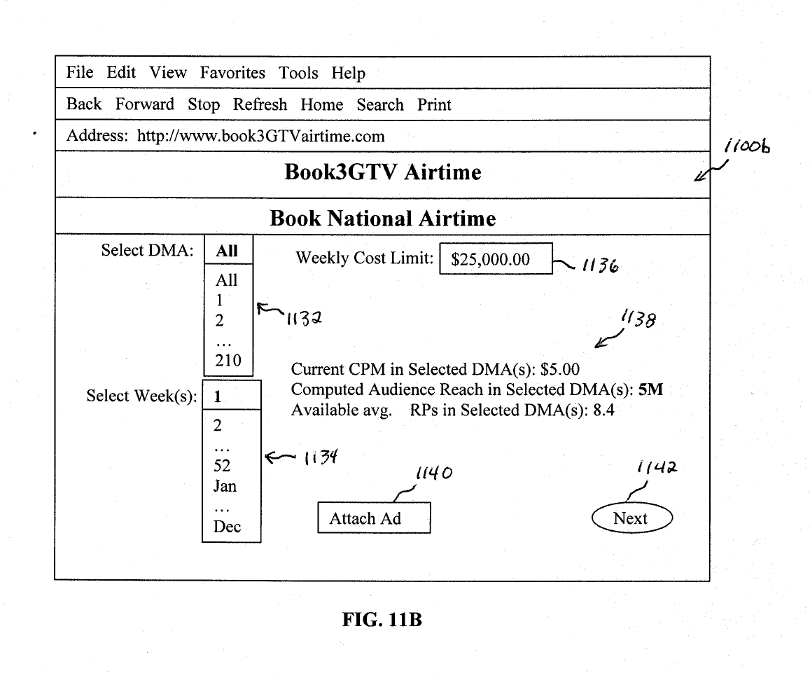

FIGS. 11A and 11B are screenshots of illustrative graphical user interfaces displayed on a browser that enables a user to book airtime on electronic display network(s) operating within local affiliates of the network service provider;

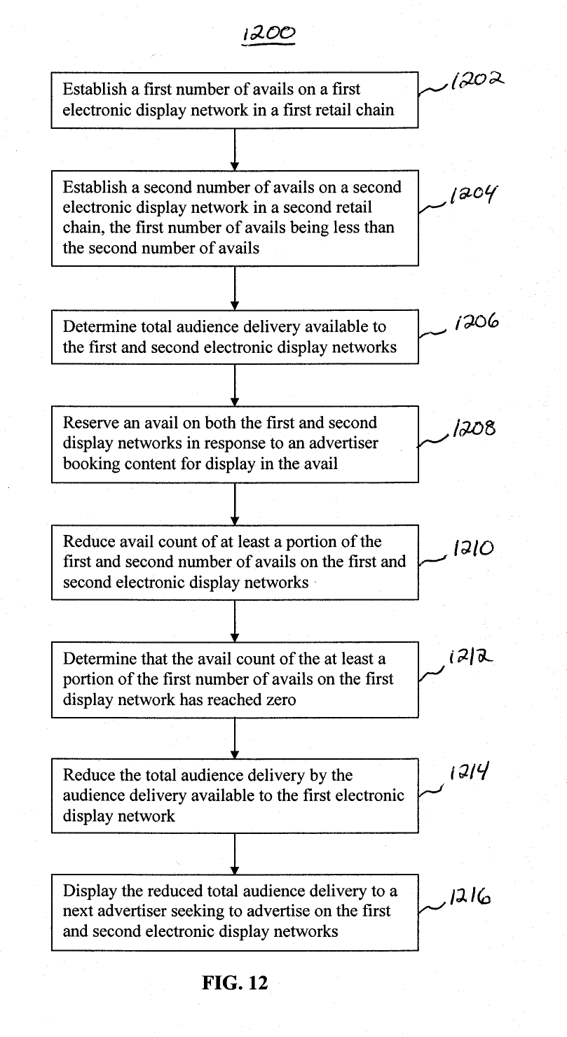

FIG. 12 is a flow diagram of an illustrative process for the network service provider managing avails on an electronic display network being operated within multiple retail chains or local affiliates of the network service provider in which retail store parameters and shopper or audience metrics are different in the different retail chains;

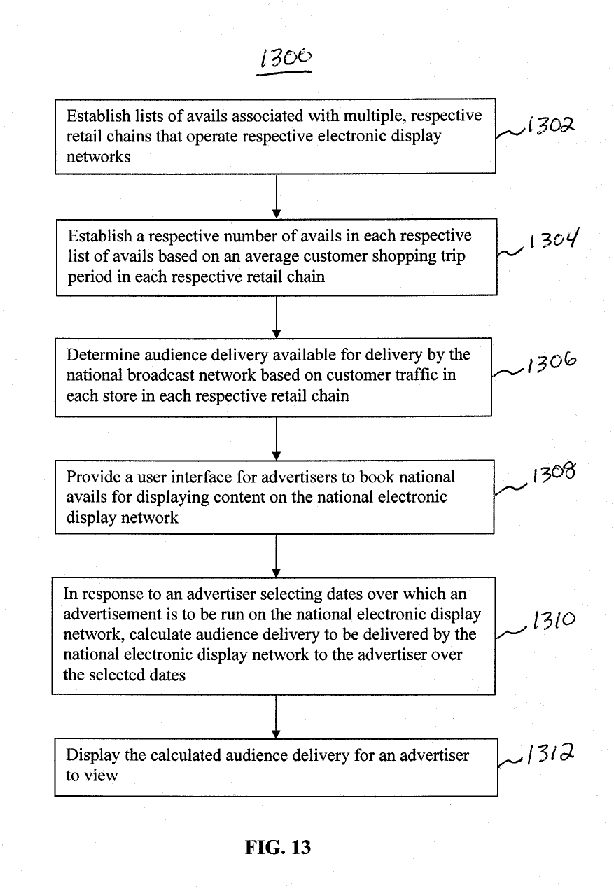

FIG. 13 is a flow diagram of an illustrative process for managing national airtime on a network of electronic display network located in multiple retail chains;

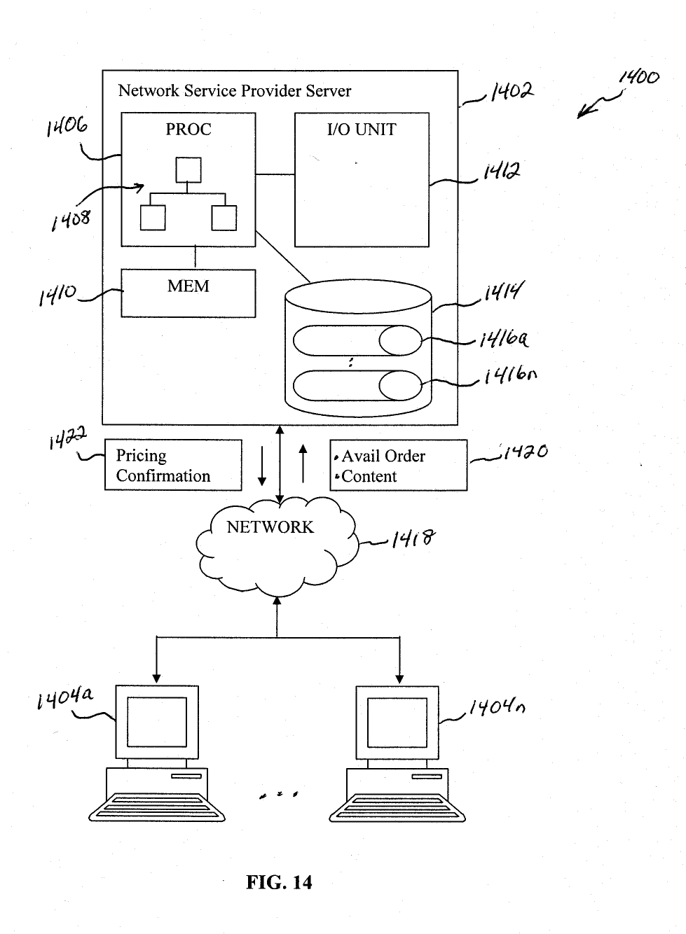

FIG. 14 is a block diagram of an illustrative system environment with a server of the network service provider configured to manage national and local airtime; and

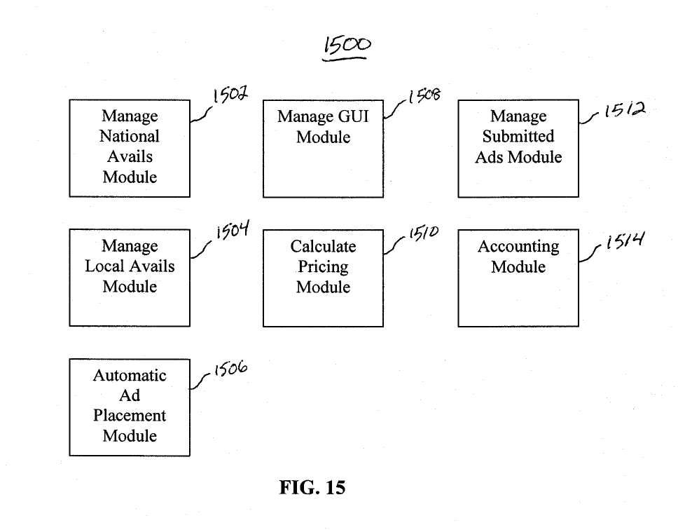

FIG. 15 is a block diagram of illustrative software modules executed by the system of FIG. 14 to provide for management of the national and local airtime of the national electronic display network.

### DETAILED DESCRIPTION

With regard to FIG. 1, a block diagram of illustrative retail chain stores 100 are shown to include retail chains 102a-102n (collectively 102), where retail chain 102a has ‘m’ stores (e.g., 356 stores) in the chain and retail chain 102n has ‘n’ stores (e.g., 1325 stores) in the chain. The collective retail chain stores 102 form a network of retail chains of a network service provider (not shown), where each of the retail chains 102 operate as local affiliates, as described in co-pending U.S. patent application Ser. No. 12/368,232, which is incorporated herein by reference in its entirety. Each retail store within respective local affiliates 102a-102n has an electronic display network with electronic displays that display content (e.g., video advertisements) simultaneously within a retail store. Retail chain 102a has electronic displays 104a-104m and 104n-104z (collectively electronic display network 104), and retail chain 102n has electronic displays 106a-106m and 106n-106z (collectively electronic display network 106). From the network service provider's point-of-view, the individual electronic display networks 104 and 106 collectively form a national network 108 and each retail chain electronic display network is a local network.

As understood in the art, retail chain stores are generally configured in different manners, where a grocery store is configured different from a pharmacy, which is configured different from a mass merchant retail store. As further understood, retail stores of different retail chains within the same industry (e.g., grocery stores) generally have different configurations (e.g., Food Lion® and Kroger®. As such, an electronic display network that is integrated into a retail store of one retail chain would be configured in a different manner from an electronic display network that is integrated into a different retail chain due to the different retail chains having different store configurations and shopper or audience metrics. Audience metrics may include an average number of minutes that shoppers shop at a retail store. By knowing the average amount of time that shoppers shop within a retail store or generally across a retail chain, an advertising “wheel” having a certain length of time may be established for displaying advertising spots on an electronic display network in the retail store or chain, as described in U.S. patent application Ser. No. 12/368,232. Although described as an “advertising wheel,” it should be understood that each time segment in the advertising wheel may contain content other than advertisements, where the terms “content” and “advertisement” may include public service announcements, traditional advertisements, traditional programming, or any other information used for public awareness, as understood in the art. For the purposes of this application, the terms “shopper” and “customer” are equivalent and mean visitors who enter a retail store, and are not limited to visitors who purchase goods at the retail store.

As an example, if an average shopping time in a one retail store is different from an average shopping time in another retail store, then the length of time of advertising wheels in the different retail stores will be different. In other words, if shoppers in one retail store tend to shop for a shorter period of time than shoppers in another retail store on average, then the advertising wheel in the retail store with shorter shopping periods will be shorter than an advertising wheel in another retail store where the shoppers shop for a longer period of time on average. To provide for media metrics that are backwardly compatible to media metrics on traditional in-home television (e.g., broadcast, cable, or satellite), the electronic display networks 104 and 106 may be configured to ensure that substantially every shopper (audience delivery) in a retail store is able to view each content segment a predetermined number of times (e.g., at least three times) (frequency of view), as described in co-pending U.S. patent application Ser. No. 12/368,232. Assuming that audience delivery and frequency of view are attainable in retail stores as described above, media metrics may be determined to provide advertisers with rating points (RPs) and gross rating points (GRPs), which are backwardly compatible to RPs and GRPs provided by traditional in-home television. It should be understood that retail media metrics may be more accurate than traditional in-home television media metrics due to a number of factors, including in-home television media metrics use estimates based on small samples, while retail media metrics are able to use purchase receipts and other “hard data” available from other store related measurement systems.

As an example of determining an advertisement wheel length, if shoppers in a retail store (or across retail stores of a retail chain) shop for 30 minutes on average, then an advertisement wheel should be 10 minutes, thereby allowing for each shopper to view each advertisement three times. As an example of determining number of time slots in an advertisement wheel, if the length of time slots is 6 seconds, then there will be 10 time slots per minute and 100 time slots per 10 minutes (i.e., 10 time slots per minute for 10 minutes) to form the advertisement wheel, which will be played or aired three times per each half-hour.

As the length of advertising wheels differs between local affiliates of a network service provider, so too does the number of time slots or avails on respective advertising wheels. If one retail chain has an average shopper spend an average of 51 minutes, then the advertisement wheel length will be 17 minutes (i.e., 51 minutes/3 frequency of view), which will provide for 170 avails of 6 second timeslots in the advertisement wheel, which will be displayed three times each 51 minutes of shopping time, in that retail chain. If a different retail chain has an average shopping period of 21 minutes, then the advertisement wheel length will be 7 minutes and there will be 70 avails of 6 second timeslots in the advertisement wheel, which will be displayed three times each 21 minutes, in that retail chain.

A network service provider, which is operating as a national network operator, that is servicing both of the above example retail chains as local affiliates, where the network service provider may partition 60% of airtime available on the electronic display network to itself and the remaining 40% of the airtime to the local affiliates (i.e., the retail chains). As an example, if an advertising wheel is 10 minutes in a retail chain, then the network service provider will have 6 of the 10 minutes to sell timeslots or otherwise use, and the local affiliate will have 4 minutes of the advertisement wheel to sell timeslots or otherwise use. If an advertising wheel is 20 minutes in another retail chain, then the network service provider will have 12 minutes of the 20 minutes to sell timeslots or otherwise use, and the local affiliate will have 8 minutes of the advertisement wheel to sell timeslots or otherwise use. Avails available to the network service provider are called “national avails,” and avails available to the local affiliate are called “local avails.” In the first example above with a 10 minute advertisement wheel, the network service provider will have the ability to sell 60 6-second timeslots, and the local affiliate will have the ability to sell 40 6-second timeslots, which totals 100 6-second timeslots.

Continuing with FIG. 1, if the retail chain store 102a has an average shopper time of 30 minutes and retail chain store 102n has an average shopper time of 21 minutes, then there will be fewer avails for the network service provider to sell in retail chain store 102n than the number of avails available to sell in retail chain store 102a. If the number of avails at each of the retail stores were set based on the shortest amount of time on average that shoppers shop in any of the retail chains, then that retail chain with the shortest length of average shopping trip period would have a frequency of view of 3, but other retail chains with higher lengths of average shopping trip periods would provide for higher frequency of view. Having a higher verifiable frequency of view would benefit advertisers as the advertisers typically only pay for RPs (delivery x frequency of view), but would limit the revenue opportunity of the network service provider and local affiliates with average shopping periods that have longer average shopping periods because the local affiliates with the longer average shopping trip periods could otherwise have longer advertising wheels and still enable an audience delivery of a three frequency of view. By configuring the advertising wheels in a disparate manner (i.e., each retail chain does not have the same length advertisement wheel as limited by the retail chain with the shortest average shopper time), the network service provider can maximize airtime at each local affiliate.

With regard to FIG. 2, a table of illustrative data 200 lists local affiliates as retail chains A-N and associated total avails in respective advertisement wheels that are based on an average shopper time at respective stores of the retail chains. As described above, the total number of avails on an electronic display network of a local affiliate may be partitioned as national avails and local avails, where the national avails may be 60% of the total avails and local avails may be 40% of the total avails. Other partition percentages may be utilized across an entire network of local affiliates or on a local affiliate by local affiliate basis. Again, the national avails are avails or time slots that are available for a network service provider of the electronic display network in each of the respective retail chains to sell or otherwise use, and the local avails are time slots that are available for the local affiliates or retail chains to sell or otherwise use on the electronic display network. It should be understood that if a top-of-the-hour news broadcast is shown or other program is utilized during airtime in any given hour, that the total avails may be proportionally reduced between the national avails and local avails. As shown in the data of FIG. 2, retail chain A has 36 total avails on an advertising wheel based on an average shopper time in retail chain A retail stores, which results in 21 national avails and 15 local avails. Retail chain N has 84 total avails on an advertising wheel based on an average shopper time in retail stores of retail chain N, which results in 50 national avails and 34 local avails.

With regard to FIG. 3, a table of illustrative data 300 showing a single local affiliate (i.e., retail chain A) with each of the retail stores in that retail chain (i.e., stores 1-1238) is provided. In addition, a DMA in which each respective store is located is listed. It should be understood that multiple stores of a retail chain may be located in any given DMA, which would increase the number of viewers per week and RPs in the DMA, but, assuming approximately the same audience metrics in each of the stores of the retail chain in the DMA, the number of avails will be the same. Of course, if audience metrics are different in retail stores of a retail chain within the DMA, then the number of avails within the retail chain electronic display network may vary. For each store, a certain number of average viewers per week is listed. Based on the number of viewers per week and the number of households in a given DMA, a certain number of RPs results using the electronic display network that ensures that substantially every shopper having an average shopping time in that retail chain is able to view each advertisement displayed on the electronic display network. It should be understood that the viewers per week or weekly retail audience and RPs may be estimated projections based on historical performance.

As further shown in FIG. 3, a total number of avails is listed. In most cases, the total number of avails in each of the stores of retail chain A is 36. However, the total number of avails is 54 in store number 3 in DMA 24 as a result of having a larger floor space than other retail stores in retail chain A or simply having longer shopping periods in DMA 24, both of which may result in having different audience metrics than that of the other retail stores. As shown, it is possible to have a disparate number of avails within a single retail chain, thereby resulting in a different playlist to be sent to different retail stores in the same retail chain to accommodate for the different number of avails and maximizing revenue within a single retail chain in the same or similar manner across multiple retail chains having different average shopper times or shopping trip periods.

With regard to FIG. 4, a table of illustrative data 400 is shown to include a listing of different local affiliates within a single DMA 114. The different local affiliates may include local affiliates A, B, D, H, M, and N. The different local affiliates are also listed with respective retail stores in DMA 114. In addition, a total number of avails in each of the different retail stores of the different local affiliates is listed. For each of the different retail stores, an average retail audience delivery per week and corresponding rating points are listed. It should be understood that rather than using rating points that gross rating points could otherwise be presented. Again, if multiple retail stores of a local affiliate are located within the same DMA, the number of total avails at the local affiliate will be the same, assuming essentially the same store parameters (e.g., size, layout, etc.), but the viewers/week or weekly retail audience and RPs will vary based on audience metrics (e.g., shoppers per week, average shopping trip time, etc.). The data 400 may be used to provide advertisers or their agencies with the ability to determine how much audience delivery per week and rating points are captured when displaying content on electronic display networks within each of the different retail stores of the different local affiliates in the DMA. The advertiser may advertise a spot on a national avail across each of the respective local affiliates of the network service provider. Alternatively, the advertiser may elect to advertise a spot on one or more local avails within select local affiliates to achieve desired media metrics (e.g., audience delivery per week and RPs) less than or equal to the maximum media metrics within the DMA.

As the audience delivery per week and RPs are media metrics that are backwardly compatible with media metrics for in-home television, an advertiser may generally perform an “apples to apples” comparison of advertising rates on the electronic display networks in the retail chains with advertising rates for traditional in-home television. However, because of the greater levels of control provided by the electronic display network (e.g., shoppers cannot change channels or fast forward past commercials, as is possible on in-home television), the efficiency for advertisers seeking to communicate with a mass audience in retail environments for advertising on the electronic display network will generally be higher than advertising on broadcast television and, hence, the cost for advertisers advertising in retail environments will be less. Furthermore, the advertisers may be billed for advertising on the in-store national network in a more efficient manner as more precise audience estimates may be generated through use of checkout receipts to estimate the number of shoppers or audience delivery. In addition, the advertiser may be able to buy greater levels of rating points in DMA 114 much beyond advertising on traditional television as a result of advertising on the electronic display networks in the local affiliates.

With regard to FIG. 5, a table of illustrative data 500 showing timeslots in an advertisement wheel in DMA 1, local affiliate A, store 2 is shown. As shown, there are 36 total timeslots, where 21 of the timeslots are designated or partitioned as being national avails and the remaining timeslots or avails are partitioned to be local avails. In managing the airtime for both the national network for the network service provider and local network of the local affiliate, an indicator or indicia (e.g., “Y” or “N”) associated with each timeslot may indicate whether the timeslot has been booked (i.e., sold) or not. In this example, there are three national avails remaining (i.e., timeslots 19-21) and two local avails remaining (i.e., timeslots 35 and 36). As further shown, a cost per thousand (CPM), for booking an avail may increase as the number of avails available to be purchased decreases. It should be understood that alternative cost bases may be utilized for pricing avails, such as cost per point (CPP), and/or cost per spot (CPS). For the national avails, there is a single $6.00 CPM avail remaining and two $7.00 CPM avails remaining, and there are two $7.50 CPM local avails remaining. In general, it is anticipated that CPMs, CPPs, and CPSs for local avails will be more expensive than CPMs, for national avails, but the opposite may be true, as well. In determining remaining avails, an avail threshold number may be utilized to determine when a remaining number of avails drops below the avail threshold number, which may be used to adjust cost per segment. It should be understood that the sequence of timeslots shown is not representative of a playlist order for displaying content on electronic displays on an electronic display network.

With regard to FIGS. 6A and 6B, a set of illustrative playlists 600a-600n (collectively 600) are shown for different retail chains A-N, respectively. Within each of the playlists 600, airtime is designated as being national and local according to a 60%/40% partition between the network service provider and local affiliates. As shown in each of the playlists 600, timeslot, region, and content file name are shown. It should be understood that if the playlists 600 showed all information used to display the spots, that (i) display weeks and, optionally, (ii) display times may also be listed in the playlists 600. As further shown in the different playlists 600a and 600n, the number of timeslots are different due to the average customer shopping time and/or other audience metric at the different retail chains (i.e., retail chain A and retail chain N) being different. In other words, retail chain A has a shorter average shopper time than retail chain N. As previously described, a shorter average shopper time in a retail store results in fewer number of timeslots within an advertisement wheel as the shoppers have less time to view the content. As proof of maximizing revenue for the network service provider, once the national avails of retail chain A are sold out, there are remaining national avails remaining on the electronic display network of retail chain N. If a disparate number of avails were not utilized across different local affiliates, then all national avails would be sold out upon the national avails of the local affiliate having the shortest average shopping time selling out, which would limit the revenue for the network service provider.

As an alternative embodiment to FIG. 5, FIG. 6 provides for the national avails to be partitioned into “national reserved” and “national DMA” avails, where national reserve avails are avails that are to be broadcast and displayed on electronic display networks at every local affiliate across all DMAs, and national DMA avails are national avails that can be purchased across multiple local affiliates within a single DMA. As the national network becomes so large that few advertisers can afford to purchase avails across the entire network due to the audience delivery being so large, advertisers may elect to purchase national DMA avails in specific DMAs. As such, the network service provider may elect to reserve national avails at each local affiliate, thereby enabling certain advertisers the ability to purchase avails on a national level and other advertisers the ability to purchase national avails within certain DMAs.

As shown in playlist 600a, timeslots 1-15 are established as national reserved avails in group 602 and timeslots 16-21 are designated as national DMA timeslots in groups 604a-604n. In the same or analogous manner, the local affiliate may choose to partition the local avails into “local reserved” avails, which are avails across the entire retail chain, and “local DMA” avails, which are avails available for selection within the retail chain on a DMA by DMA basis. Groups 606 and 608a-608n as distinguished as local reserved avails and local DMA avails, respectively. Although shown as being listed as national avails in timeslots 1-21 and local avails in timeslots 22-36, it should be understood that rather than displaying all of the national content in order and then all the local content in order, the national and local content may be intermixed, randomly or non-randomly, thereby improving attention by viewers of the electronic display network in retail chain A. In the same manner as shown in playlist 600a, the national avails of playlist 600n may be partitioned as shown by groups 610 and 612a-612n and local avails as shown by groups 614 and 616a-616n. It should be understood that other partitions of the avails in each of the different retail chains may be performed to maximize revenue and incentivize advertisers to place content on the electronic display networks.

With regard to FIG. 7, a table of illustrative data 700 that is sorted by DMA to allow the network service provider to determine (i) total national avails within local affiliates within each DMA and (ii) total local avails at each local affiliate within each DMA is shown. In addition, data 700 enables the network service provider to monitor (i) total national avails remaining at the local affiliates and (ii) total local avails remaining at the local affiliates in each DMA. Local affiliates may also monitor how many local avails are remaining. By monitoring the number of national and local avails remaining at the local affiliates within each of the DMAs, the network service provider and respective local affiliates may be able to fixedly (i.e., preset sequence of prices based on supply and demand, for example) or dynamically (i.e., change over time in a non-preset manner based on supply and demand or other factors) change prices for advertising in national and local airtime. As shown in FIG. 7, there are multiple groups 702a-702n that are distinguished by DMA. Currently, there are 210 designated market areas as established by The Nielsen Company in the United States. Within each DMA, the network service provider may have retail stores of local affiliates. There may be one or more retail stores (e.g., Food Lion®) in any given DMA. There may also be no retail stores of local affiliates in any given DMA. Data 700 is simplified by showing only a single retail store in each of the DMAs. However, the principles of the present invention provide for multiple retail stores or no retail stores of any given retail chain in each respective DMA.

As shown in group 702a, DMA 1 has local affiliate C, which has a total of 42 national avails and 28 local avails. At the time of the data 700 being viewed, the total number of national avails remaining at local affiliate C is zero and the total number of local avails remaining at the local affiliate C is 6. Because there are no national avails remaining at the local affiliate, the potential audience delivery and Rating Points that may be accessed by an advertiser that desires to advertise in DMA 1 is the aggregate of audience delivery to all local affiliates A-N as reduced by the audience delivery and Rating Points provided by local affiliate C. Furthermore, as the number of viewers and Rating Points becomes more scarce within any particular DMA, the price for purchasing available national or local avails may increase due to there being a lower supply and higher demand for avails.

With regard to FIG. 8, a table of illustrative data 800 that is an extension of data 700 (FIG. 7) is shown to include both national reserved and local reserved avails, as previously described with regard to FIG. 6. As shown, groups 802a-802n are associated with each of the respective DMAs 1 through 210. The total national avails shown in FIG. 7 for each of the local affiliates A-N are shown in FIG. 8 as being partitioned to be total national reserved avails at local affiliate 804a and total national DMA avails at local affiliate 804b. The local avails are also partitioned to be total local reserved avails at local affiliate 806a and total local DMA avails at local affiliate 806b. As an example, local affiliate A in DMA 1 has a total of 54 total national avails and 36 total local avails, as shown in FIG. 7, and the same local affiliate has 32 total national reserved avails and 22 total national DMA avails (32+22=54 total national avails) and 22 total local reserved avails and 14 total local DMA avails (22+14=36 total local avails). As shown in the example, the combination of the total national reserved avails and total national DMA avails, when summed, result in the same total number of national avails as shown in FIG. 7. As another example, in DMA 1, local affiliate C has 25 total national reserved avails and 17 total national DMA avails, which, when summed, is 42 total national avails, as shown in FIG. 7, DMA 1, local affiliate C.

The avails remaining data 808a, 808b, 810a, and 810b may be used to provide the network service provider and respective local affiliates with a variety of information, such as avail sales rates and assist in setting avail pricing. The partition of national avails as including national reserved avails and national DMA avails is shown to be a 60%/40% split. It should be understood that any other partition methodology, including a dynamic partition methodology in which the partition is based on demand for national avails versus DMA avails on a national level may be utilized. It should further be understood that if the network service provider decides to add another national reserved avail and not every local affiliate has available national DMA avails for converting to a national reserved avails, that the network service provider can change the partition in each local affiliate over time as national DMA avails become available. As the number of national reserved avails and national DMA avails are sold to advertisers, the number of respective avails are reduced, as shown in data 800 as total national reserved avails remaining in DMA 808a, total national DMA avails remaining in DMA 808b, total local reserved avails remaining in DMA 810a and total local DMA avails remaining in DMA 810b.

With regard to FIG. 9, a number of different playlists 902a-1, 902a-2, and 902a-3 (collectively 902a) are shown as different day parts for content to be displayed in retail chain A, and playlists 902n-1, 902n-2, and 902n-3 (collectively 902n) are shown for retail chain N. The playlists 902a and 902n allow for the network service provider and local affiliates to allow advertisers to advertise in certain day parts (e.g., morning, afternoon, and evening) to reach different audience demographics (e.g., age, gender, lifestyle). To accommodate for advertisers to be able to selectively play content during distinct or all-day parts, the tables presented in FIGS. 3-5, 7, and 8 may be expanded to accommodate avails in particular day parts, thereby allowing both the network service provider and local affiliates to manage airtime in the different day parts. For example, rather than simply listing the audience delivery per week, such as in FIG. 3, the audience delivery per week may be distinguished across each of the different day parts (i.e., audience delivery per day part). RPs and total avails would also be changed to accommodate for the different day parts.

With regard to FIG. 10A, an illustration of an illustrative map 1000a of the United States showing distinct DMAs is shown. There are currently 210 different DMAs in the United States. Advertisers generally desire to advertise to as many households within each DMA as possible. Traditionally, advertisers used television to achieve their goal of advertising to as many households within a DMA as possible. However, utilizing the principles of the present invention, advertisers may reach household members by advertising on electronic display networks within retail stores. As shown in FIG. 10A, DMA 114 in North Texas, which includes the Dallas-Fort Worth Metroplex, may be targeted by advertisers through both traditional television broadcasting and broadcasting over electronic display networks within retail environments.

As shown in FIG. 10B, an illustrative map 1000b of DMA 114 is shown. Within DMA 114, there are a number of different retail stores that are local affiliates of the network service provider. The local affiliates include local affiliate A, B, D, H, N, and M. Within DMA 114, local affiliate A has store number 37, local affiliate B has retail store number 12, local affiliate B has store number 284, local affiliate H has store number 771, local affiliate N has retail store 3, and local affiliate M has retail store 1742. In addition, each of the retail stores have a certain number of total avails located therein. As shown, local affiliate A, retail store 37 has 36 total avails, local affiliate B store 12 has 84 avails, and so on. Rather than showing total avails, it should be understood that total national avails and total local avails may be shown. Alternatively, rather than showing total avails, remaining avails, both national and local, may be shown in FIG. 10B. In one embodiment, the illustrative map 1000b may be interactive to allow the network service provider, local affiliate, and advertisers to manage and/or advertise on the electronic display network of the network service provider within retail store environments. By being interactive, a user may select one or more retail stores to purchase either local or national airtime and submit content (e.g., advertisement) to the network service provider for distribution to the desired store(s) of local affiliate(s), as provided by FIG. 11A.

With regard to FIG. 11A, an illustrative graphical user interface (GUI) 1100a is shown to include two sections, including a “book national airtime” section 1102a and “book local airtime” section 1102b. The GUI 1100 allows for advertisers or their agencies to purchase airtime in both national and local avails. In purchasing national avails, the advertiser may select a DMA 1104a by using a drop-down menu 1104b, where the advertiser may select any or all of the DMAs (e.g., DMA 2, 1106) in which to advertise in national airtime. In purchasing national airtime, the advertiser is actually requesting to advertise across all or multiple local affiliates in any selected DMA. As shown, information 1108 may be displayed to present to a user available audience delivery in selected DMA(s) (e.g., 3.457M, where M is ‘thousands’) and available RPs within the selected DMA(s) (e.g., 7.8 RPs in all DMAs). The available audience delivery and RPs are an estimate as the actual audience delivery and RPs will not be known until after the selected week(s) are complete. If RPs are across multiple DMAs, then the RPs may be an average RP of the different DMAs or a cumulative sum of the RPs across the different DMAs. Current cost per thousand (i.e., CPM) in the selected DMA(s) is $6.25 (optionally computed as an average if more than one DMA is selected), and total cost for the selected DMA for the audience delivery is $21,606.25 (i.e., 3,457M viewers×$6.25).

The user may also select dates (e.g., weeks or months) over which content is to run on the national network using pull-down menu 1110 or any other graphical user element, as understood in the art, and the total cost may be computed based on the dates selected. The dates selected may affect the audience delivery, for example, thereby affecting the computed price. In one embodiment, the audience delivery may vary based on the dates using historical audience delivery during those dates. For example, audience delivery may vary during holidays (e.g., fewer shoppers over 3-day weekends or more shoppers prior to Christmas).

The user may attach content for submission to a network service provider for distribution to selected retail stores of local affiliates in the selected DMA(s) by selecting soft-button 1112, which allows for the user to select a content file, as understood in the art. If the user is complete with selection of the distribution for the content, the user may select soft-button 1114.

The GUI 1100 may operate in the same or similar manner whether or not national and local avails are partitioned, as provided in FIG. 6B. However, the GUI 1100 may “gray out” the “All” DMA selection in drop-down menu 1104b if all national reserved avails are sold out or “gray out” particular DMAs if all national DMA avails are sold out in particular DMAs. Because the network service provider is able to sell national avails across different local affiliates, it is possible to provide a selection of one or more retail chains in section 1102a.

The advertiser may also elect to book local airtime in section 1102b by selecting a retail chain 1116a (e.g., Food Lion®), or select a different retail chain that is a local affiliate of the network service provider by using a pull-down menu 1116b. The user may select, for example, CVS 1118 for advertising in that local affiliate of the network service provider. The user may also select a particular DMA 1120, or select another DMA (e.g., DMA 21, 1122), or select all DMAs (selection not shown), in which the local affiliate has retail stores. The user may select dates for content to play or air on the electronic display network of the local affiliate. As shown, the user may select a particular week 1124a or month in a pull-down menu 1124b. It should be understood that an alternative date selection graphical user element, such as a calendar, may be utilized to enable a user to select dates.

Information 1126 may also be presented to the user that includes available audience delivery in the selected DMA(s), available rating points for the selected retail chain in the selected DMA(s), current cost per thousand for advertising in the selected DMA(s) at the selected retail chain, and total cost for placing content in the selected retail chain in the selected DMA(s). The user may attach a content file by selecting soft-button 1128. If the user has completed selection of the retail chain and DMA(s), then the user may select soft-button 1130 to complete purchasing. It should be understood that national and local avails may alternatively sold using different GUIs or mediums other than the Internet. It should further be understood that local airtime may be sold using a distinct GUI from a GUI selling national airtime. For example, a local affiliate may have a website or other means for selling local airtime without providing an advertiser the ability to select to advertise on another local affiliate's electronic display network.

With regard to FIG. 11B, a screenshot of an illustrative graphical user interface 1100b that enables an advertiser or its agency to book a national avail on a national electronic display network is shown. In one embodiment, a graphical user interface element 1132 may enable the advertiser to select one or more DMAs in which to place the content. Rather than the graphical user interface element 1132 being a drop-down menu, it should be understood that alternative graphical user elements, such as radio buttons, may be utilized to enable the user to select distinct DMAs. Another GUI element 1134 may enable the user to select time periods over which to place the content. To accommodate an advertiser who has a set budget for advertising, a text entry field 1136 or other GUI element may enable the user to enter a cost limit (e.g., weekly cost limit). If the user enters a cost limit, a computing system may execute an algorithm that determines local affiliates and/or geographic regions in which the cost limit can be achieved. In one embodiment, rather than the user having to select one or more DMAs, the user may select certain geographic region types, such as cities, town, rural, etc., using a GUI element (not shown) in which the user desires to advertise, thereby allowing the system to automatically select DMAs that meet the geographic region and cost limit criteria.

In addition to the user having the ability to select geographic region types, the user may further have the ability to select retail store types, such as grocery store, mass merchant, pharmacy, which the algorithm may further incorporate when selecting retail stores in which to display the content to meet the weekly cost limit. In another embodiment, rather than the user being able to select an upper weekly cost limit, the user may be presented with a second GUI element (not shown) that enables the user to enter a weekly lower cost limit (e.g., $5,000.00), which the algorithm may use when selecting retail stores in which to play the content. In yet another embodiment, rather than selecting cost limits, the user may be able to enter upper and lower audience delivery or desired RPs into GUI elements (not shown) that the algorithm is to follow for selecting retail stores in which to play the content. It should be understood that media metrics (e.g., RPs) and financial parameters (e.g., average weekly cost limit) may be selectable or enterable for an advertiser to allow the system to automatically select retail stores in which to play the content. Still yet, demographic parameters that are shopper focused (e.g., average annual income, gender, age, etc.) may be selectable by a user placing content in national and/or local avails on the national electronic display network. It should be further understood that multiple parameters (e.g., geographic, financial, and/or demographic) may be utilized by the algorithm to automatically select retail stores and/or chains in which to play the content.

With regard to FIG. 12, a flow diagram of an illustrative process 1200 for managing avails in different retail chains is presented. The process 1200 starts at step 1202, where a first number of avails may be established on a first electronic display network in a first retail chain. At step 1204, a second number of avails may be established on a second electronic display network in a second retail chain, the first and second electronic display networks being configured to receive content for display in the purchased time slots of the advertising wheels via a communications network. In one embodiment, the first number of avails is less than the second number of avails, which is indicative of the customers at the first retail chain having an average shopping trip period being less than the average shopping trip period of customers at the second retail chain. Total audience delivery available to the first and second electronic display networks may be determined at step 1206. In determining total audience delivery, a total number of customers or shoppers who visit stores within the first and second retail chains may be determined. In addition, in determining total audience delivery, a scale factor, such as 1.2, may be used to multiply total number of receipts collected at each retail store of the retail chains to account for children of shoppers and shoppers who shop in pairs (e.g., husband and wife, friends, etc.), for example.

At step 1208, an avail may be reserved on the first and second display networks in response to an advertiser booking content for display in the avail. Avail count of at least a portion of the first and second number of avails may be reduced on the first and second electronic display networks at step 1210. At step 1212, a determination that the avail count of the at least a portion of the first number of avails on the first display network has reached zero may be made. At step 1214, the total audience delivery may be reduced by the audience delivery available to the first electronic display network may be determined. At step 1216, the reduced total audience delivery may be displayed to a next advertiser seeking to advertise on the first and second electronic display networks. In one embodiment, the process 1200 may be performed on a DMA by DMA basis. In other words, if the advertiser selects to advertise in one or more distinct DMAs, then the process 1200 may be performed within the selected DMA(s) rather than across every DMA in which the first and second retail chains operate.

In response to determining that all avails are booked in the at least a portion of the first number of avails (e.g., national avails) on the first electronic display network, a new price for booking avails on the second electronic display network may be computed. Because fewer avails are available for booking, the price for booking may increase despite the fact that the total audience delivery has decreased due to supply and demand principles. In one embodiment, the at least a portion of the first and second number of avails on the first and second electronic display network may be reserved for the network service provider to use or sell as national airtime, and any remaining portion of the first and second number of avails on the first and second electronic display network may be reserved for the respective first and second retail chains to use or sell as local airtime, thereby creating partitioned networks between the network service provider and its local affiliates.

FIG. 13 is a flow diagram of an illustrative process 1300 for managing national airtime on a network of display networks located in multiple retail chains. The process 1300 may include establishing multiple lists of avails associated with multiple, respective retail chains that operate respective electronic display networks at step 1302. An aggregate of the electronic display networks define a national electronic display network, and the respective display networks define local electronic display networks. At step 1304, a number of avails may be established in each of the lists of avails based on an average customer shopping trip periods in each respective retail chain. At least a portion of a total number of avails on each respective local electronic display network being national avails, and a remaining portion of the total number of avails on each respective local electronic display network being respective local avails.

At step 1306, an audience delivery available for delivery by the national broadcast network may be determined based on customer traffic in each store in each respective retail chain. It should be understood that the audience delivery is actually an estimated or projected audience delivery. The available audience delivery is predictable, but is an estimate until an actual measurement or better estimate can be made after completion of the selected dates. At step 1308, a user interface may be provided for advertisers to book national avails for displaying content on the national electronic display network. The user interface may provide selectable dates during which content is to be run on the national electronic display network. At step 1310, in response to an advertiser selecting dates over which content is to be run on the national electronic display network, an audience delivery to be delivered by the national electronic display network to the advertiser over the selected dates may be calculated. The calculated audience delivery may be displayed for an advertiser to view at step 1312. Because the audience delivery is a projected audience delivery, optionally historically based, the audience delivery is an estimate.

In one embodiment, in response to an advertiser booking a national avail on the national electronic display network, the number of national avails may be reduced in each of the lists of avails that have at least one national avail available for booking. A determination may be made as to whether all of the national avails in a list of avails have been booked. If all of the national avails in the list of avails have been booked, then audience delivery available for delivery for other content to be booked in the remaining national avails may be recalculated. In other words, the audience delivery will be reduced by the audience delivery of the retail chain associated with the list of avails in which all of the national avails have been booked. If not all of the national avails in any of the lists of avails have been booked, then no recalculation of the audience delivery available for other content to be booked in the remaining national avails may be made. If it is determined that a national timeslot from a previously filled list of avails becomes available, then audience delivery may be recalculated to include that national avail. In other words, the audience delivery of the retail chain that was previously unavailable due to all of its national avails being unavailable may be added back when calculating the audience delivery.

In one embodiment, a selection of one or more DMAs in which the advertiser desires to place content on the national electronic display network may be received from an advertiser. Selection of one or more DMAs may allow an advertiser to advertise across multiple retail chains, but in more targeted geographic locations than across the entire country.

FIG. 14 is a block diagram of an illustrative system environment 1400 with a server 1402 of the network service provider configured to manage national and local airtime. Users of advertisers and/or advertising agencies may utilize computers 1404a-1404n (collectively 1404) to communicate with the server 1402. The server 1402 may include a processing unit 1406 that includes one or more computer processors that executes software 1408. The software 1408 may be configured to perform management of airtime and content, as further provided in FIG. 15. The processing unit 1406 may be in communication with memory 1410 that is configured to store data and software, input/output (I/O) unit, and storage unit 1414 that stores one or more data repositories 1416a-1416n (collectively 1416). The I/O unit may be configured to communicate data over one or more communications network 1418 using any communications protocols, as understood in the art. In one embodiment, the network 1418 may be the Internet, satellite network, mobile network, or any combination thereof. The data repositories 1416 may be configured to store information associated with each local affiliate, including respective audience metrics, avails, playlists, advertisement content, DMA locations, and any other information that enables the server 1402 to price avail bookings for advertisers when placing content (e.g., advertisement content). In one embodiment, users using the computers 1404 may submit an avail order and content 1420 and the server may compute pricing and provide a confirmation 1422 for the users when placing content on the national electronic display network. It should be understood that other information that enables an advertiser or other entity to book content on the national electronic display network, including booking national avails and/or local avails.

FIG. 15 is a block diagram of illustrative software modules 1500 executed by the system of FIG. 14 to provide for management of the national and local airtime of the national electronic display network. The software modules 1500 may include a manage national avails module 1502 that is configured to manage national avails. As the national avails may be 60% of the avails on each local affiliate electronic display network, the manage national avails module 1502 may maintain how many national avails are booked and available at each local affiliate. In addition, the module 1502 may be configured to manage national reserved and national DMA avails, as described herein.

A manage local avails module 1504 may be configured to manage local avails at each respective local affiliate. The manage local avails module 1504 may maintain how many local avails are booked and available at each respective local affiliate. In addition, the module 1504 may be configured to manage local reserved and local DMA avails, as described herein.

An automatic ad placement module 1506 may be configured to automatically determine specific locations and periods of time for placing content for advertisers to meet requested advertising parameters. For example, if an advertiser enters a minimum and maximum budget or desired RPs or GRPs for displaying content on an electronic display network, the automatic ad placement module 1506 may compute cost for displaying the content on a national basis or DMA basis based on audience delivery estimates or other media metrics and number of days for displaying the content. It should be understood that the number of days may be represented in weeks or months. The module 1506 may be configured for handling both national and local electronic display networks. If the advertiser submits geographic locations (e.g., one or more DMAs) in which content is to be displayed, then the module 1506 may restrict placement to those geographic locations.

A manage GUI module 1508 may be configured to manage one or more graphical user interfaces that advertisers may interface to book avails for content to be displayed. The graphical user interfaces (e.g., FIGS. 11A and 11B) may provide for booking national avails and/or local avails. In one embodiment, the network service provider may provide a GUI for local affiliates to use as a front-end to enable advertisers to book local avails. Graphical user interface elements, such as drop-down menus, radio buttons, and other selectable elements, may allow for a user to enter information that is used by other software modules 1500 to the information to reserve avails and compute pricing for advertisers when booking content on the national electronic display network. The manage GUI module 1508 may further be configured to receive and display information from other software modules 1500, such as calculate pricing module 1510, and display the information, such as audience delivery, RPs, price for advertising over selected dates, geographic regions, and stores of local affiliates, for example.

A calculate pricing module 1510 may be configured to compute pricing for an advertiser when booking airtime or avails on the national electronic display network, either in national or local avails. The calculate pricing module 1510 may determine whether the user has selected one or more DMAs, audience delivery in retail stores in which content will be displayed, the number of rating points, or any other media metric that the network service provider or local affiliate desires to use to compute pricing for booking avails.

A manage submitted ads module 1512 may be configured to receive and manage content (e.g., advertising content) that is submitted by advertisers or their agencies for distribution to electronic displays at retail stores of the local affiliates. The manage submitted ads module 1512 may further be configured to populate playlists of local affiliates to ensure that the content is properly and timely distributed to the electronic displays in the retail stores of the local affiliates.

An accounting module 1514 may be configured to account for the number of estimated actual viewers (i.e., audience delivery) were able to view each content segment at each retail store of each local affiliate. In one embodiment, the accounting module 1514 may receive store data, such as number of receipts, from each of the local affiliates to determine how may shoppers purchased items and then use a scale factor, such as 1.2, to estimate the total number of customers (i.e., audience delivery) who were at the store for the time period (e.g., week) during which the store data is collected. The module 1514 may then compute the audience delivery for the advertisement purchase or buy and generate a bill for the advertisers to pay based on the estimated audience delivery. It should be understood that the modules 1500 are illustrative and that other modules may be utilized to perform management of avails and content.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A method for managing avails on advertisement wheels in different retail chains, said method comprising:
establishing a first number of avails on a first electronic display network in a first retail chain;
establishing a second number of avails on a second electronic display network in a second retail chain, the first and second electronic display networks being configured to receive advertising content for display in the avails via a communications network, the first number of avails being less than the second number of avails;
determining total audience delivery available to the first and second electronic display networks;
reserving an avail on both the first and second display networks in response to an advertiser booking content for display in the avail;
in response to the avail being booked, reducing avail count of at least a portion of the first and second number of avails on the first and second electronic display networks;
determining that the avail count of the at least a portion of the first number of avails on the first display network has reached zero;
reducing the total audience delivery by the audience delivery available to the first electronic display network; and
displaying the reduced total audience delivery to a next advertiser seeking to book an avail on the first and second electronic display networks.

2. The method according to claim 1, wherein establishing the first and second number of avails includes establishing the avails over multiple time segments throughout days of a week.

3. The method according to claim 1, further comprising determining rating points over different geographic areas based on audience delivery within the first and second retail chains.

4. The method according to claim 3, wherein the different geographic areas are different designated marketing areas (DMAs).

5. The method according to claim 1, further comprising, in response to determining that all of the avails are booked in the at least a portion of the first number of avails on the first electronic display network, computing a new price for booking avails on the second electronic display network.

6. The method according to claim 5, wherein computing the new price for booking avails on the second display network is based on total avails remaining on the second electronic display network.

7. The method according to claim 1, further comprising:
determining a number of available avails on the first electronic display network;
determining that the number of available avails on the first electronic display network drops below a threshold number; and
increasing a price for booking avails on the first display network in response to the number of available avails on the first electronic display network dropping below the threshold number.

8. The method according to claim 1, further comprising, in response to an avail becoming available in the at least a portion of the first number of avails on the first electronic display network after none were previously available, increasing the total audience delivery by the audience delivery available to the first electronic display network.

9. The method according to claim 1, further comprising reserving the at least a portion of the first and second number of avails on the first and second electronic display networks as being available for a network service provider to use or sell.

10. The method according to claim 9, further comprising reserving any remaining portion of the first and second number of avails on the first and second electronic display networks as being available for respective first and second retail chains to use or sell.

11. A method for managing national airtime on a network of display networks located in multiple retail chains, said method comprising:
establishing a plurality of lists of avails associated with a plurality of respective retail chains that operate respective electronic display networks, an aggregate of the electronic display networks defining a national electronic display network and the respective display networks defining local electronic display networks;
establishing a respective number of avails in each respective list of avails based on an average customer shopping trip period in each respective retail chain, at least a portion of the respective number of avails on each respective local electronic display network being national avails and a remaining portion of the respective number of avails on each respective local electronic display network being respective local avails;
determining audience delivery available for delivery by the national broadcast network based on customer traffic in each store in each respective retail chain;
providing a user interface for advertisers to book national avails for displaying content on the national electronic display network, the user interface providing selectable dates during which content is to be run on the national electronic display network;
in response to an advertiser selecting dates over which content is to be run on the national electronic display network, calculating audience delivery to be delivered by the national electronic display network to the advertiser over the selected dates; and
displaying the calculated audience delivery for an advertiser to view.

12. The method according to claim 11, further comprising, in response to an advertiser booking a national avail on the national broadcast network, reducing the number of national avails in each of the lists of avails that have at least one national avail available for booking.

13. The method according to claim 12, further comprising:
determining whether all national avails in a list of avails have been booked;
if all national avails in the list of avails have been booked, recalculating audience delivery available for other content to be booked in the remaining national avails, otherwise, not recalculating the audience delivery; and
displaying the recalculated audience delivery for an advertiser to view.

14. The method according to claim 13, further comprising:
determining whether a national avail from a previously filled list of avails becomes available;
if a national avail from a previously filled list of national avails becomes available, recalculating audience delivery available for delivery for other content including that national avail, otherwise, not recalculating the audience delivery; and
displaying the recalculated audience delivery for an advertiser to view.

15. The method according to claim 11, further comprising:
receiving a selection of a DMA in which the advertiser desires to place content on the national broadcast network; and
wherein calculating audience delivery to be delivered includes calculating audience delivery to be delivered for the selected DMA for the selected dates and times.

16. The method according to claim 11, further comprising reserving a predetermined number of national avails on each of the lists of national avails for non-DMA targeted advertising.

17. The method according to claim 11, further comprising:
computing a price for placing content based on the computed audience delivery; and
displaying the computed price.

18. The method according to claim 11, further comprising:
computing, in response to a user request for a desired audience delivery via the user interface, a number of days content needs to be broadcast over the national broadcast network to achieve the requested desired audience delivery; and
displaying the computed number of days.

19. The method according to claim 11, further comprising:
determining, in response to a user submission of a cost limit and time duration for displaying content in a national avail on the national broadcast network, particular local affiliates and geographic areas to achieve the cost limit;
computing an audience delivery that will be achieved from displaying the content in the particular local affiliates and geographic areas; and
displaying the audience delivery.

20. The method according to claim 11, further comprising:
calculating average rating points (RPs) available for delivery of the content in a national avail by the national broadcast network based on the calculated audience delivery; and
displaying the calculated average RPs for the advertiser to view.

21. A system for managing national airtime on a network of display networks located in multiple retail chains, said system comprising:
a memory configured to store data used to manage the national airtime on a network of display networks;
an input/output (I/O) unit configured to communicate data over a communications network;
a processing unit in communication with said memory and said I/O unit, said processing unit configured to:
establish a plurality of lists of avails associated with a plurality of respective retail chains that operate respective electronic display networks, an aggregate of the electronic display networks defining a national electronic display network and the respective display networks defining local electronic display networks;
establish a respective number of avails in each respective list of avails based on an average customer shopping trip period in each respective retail chain, at least a portion of the respective number of avails on each respective local electronic display network being national avails and a remaining portion of the respective number of avails on each respective local electronic display network being respective local avails;
determine audience delivery available for delivery by the national broadcast network based on customer traffic in each store in each respective retail chain;
provide a user interface for advertisers to book national avails for displaying content on the national electronic display network, the user interface providing selectable dates during which content is to be run on the national electronic display network;
in response to an advertiser selecting dates over which content is to be run on the national electronic display network, calculate audience delivery to be delivered by the national electronic display network to the advertiser over the selected dates; and
display the calculated audience delivery for an advertiser to view.

22. The system according to claim 21, wherein said processing unit is further configured to, in response to an advertiser booking an avail on the broadcast network, reduce the number of avails in each of the lists of avails with avails that are available for booking.

23. The system according to claim 22, wherein said processing unit is further configured to:
determine whether all avails in a list of avails have been booked; and
if all national avails in the list of avails have been booked, recalculate audience delivery available for other content to be booked in the remaining national avails, otherwise, not recalculating the audience delivery; and
display the recalculated audience delivery for an advertiser to view.

24. The system according to claim 23, wherein said processing unit is further configured to:
determine whether a national avail from a previously filled list of avails becomes available;
if a national avail from a previously filled list of national avails becomes available, recalculate audience delivery available for delivery for other content including that national avail, otherwise, not recalculate the audience delivery; and
display the recalculated audience delivery for an advertiser to view.

25. The system according to claim 21, wherein said processing unit is further configured to:
receive a selection of a DMA in which the advertiser desires to place content on the national broadcast network; and
wherein calculating audience delivery to be delivered includes calculating audience delivery to be delivered for the selected DMA for the selected dates and times.

26. The system according to claim 21, wherein said processing unit is further configured to reserve a predetermined number of national avails on each of the lists of national avails for non-DMA targeted advertising.

27. The system according to claim 21, wherein said processing unit is further configured to:
compute a price for placing content based on the computed audience delivery; and
display the computed price.

28. The system according to claim 21, wherein said processing unit is further configured to:
compute, in response to a user request for a desired audience delivery via the user interface, a number of days content needs to be broadcast over the national broadcast network to achieve the requested desired audience delivery; and
display the computed number of days.

29. The system according to claim 21, wherein said processing unit is further configured to:
determine, in response to a user submission of a cost limit and time duration for displaying content in a national avail on the national broadcast network, particular local affiliates and geographic areas to achieve the cost limit;
compute an audience delivery that will be achieved from displaying the content in the particular local affiliates and geographic areas; and
display the audience delivery.

30. The system according to claim 21, wherein said processing unit is further configured to:
calculate average rating points (RPs) available for delivery of the content in a national avail by the national broadcast network based on the calculated audience delivery; and
display the calculated average rating points for the advertiser to view.
